(19) United States
(12) Patent Application Publication
(10) Pub. No.: US 2008/0202837 A1
(43) Pub. Date: Aug. 28, 2008

(54) Omnidirectional Electric Wheelchair Control System

(76) Inventors: Antonio Fernando Macedo Ribeiro, Braga (PT); Pedro Luis Da Costa E Silva, Braga (PT); Ivo Mauro Correia Moutinho, Braga (PT); Nino Sancho Sampaio Martins Pereira, Braga (PT); Paula Alexandre Sousa Braga, Braga (PT)

Correspondence Address: NEXSEN PRUET, LLC, P.O. BOX 10648, GREENVILLE, SC, 29603, US

(21) Appl. No.: 12/067,639

(22) PCT Filed: Sep. 21, 2006
(86) PCT No.: PCT/PT2006/000022

§ 371 Date: Mar. 20, 2008

(30) Foreign Application Priority Data
Sep. 21, 2005 (PT) 103354

(51) Int. Cl. B60K 17/34

(52) U.S. Cl. 180/236

(57) ABSTRACT

This invention refers to a wheelchair control system which enables them to move in an omnidirectional way without much effort by its user. The system is made up of a base (1) where the wheels and motors are attached (2) the batteries (3). The necessary electronics to the full functioning of the wheelchair are located on the second level (4). On the next level up, is placed the processing unit (5). Over all this structure is placed the wheelchair seat (6). On its arm is mounted a joystick (or other wheelchair controlling device) (7) as well as a digital screen (8) so that the user can write and read the all the wheelchair information. The processing unit on board can also receive information from sensors located all around the wheelchair to automatically avoid obstacles. Additionally, this wheelchair control system is electrically fed through rechargeable batteries or fuel cells (3), offering great usage autonomy.

### TECHNICAL DOMAIN

The present invention refers to a electric wheelchair control system which uses omnidirectional wheels operated by independent motors. This control system in such wheelchair actuates each motor independently to each wheel, allowing moving on any direction without manoeuvres, as translation and/or rotation without demanding a great physical effort from the user.

### INVENTION ABSTRACT

This invention refers to a omnidirectional electric wheelchair control system which enables it to move in an omnidirectional way using a joystick or any other similar device and/or a wireless remote control. So, wheelchair control system consists of one base with at least 3 omnidirectional wheels and their motors, a processing unit, and a simple and user friendly interface (tactile screen) for the user. This wheelchair control system can be operated by remote control and it receives sensory data from sensors attached to the wheelchair base, in order to avoid obstacles.

Additionally, the wheelchair control system is electrically fed by rechargeable batteries or fuel cells, allowing longer usage autonomy.

### STATE OF THE ART

When a person suffers from a physical disability, normally, his self-esteem is low and feels many problems due to his quality of life being lower than average, mainly due to his lack of mobility.

In the last few years people with physical limitations have been benefiting from more and more sophisticated wheelchairs with more devices which offer them greater comfort and quality of life. Some wheelchairs are manual, other contain some form of motorization which allows them to go all over longer distances without wear out his user, but always with some limitation what concerns the battery life.

A wheelchair offers to a disabled person with moving limitations not just an increase in mobility, although still reduced due to the many still existent architectonic barriers, as well as his improved quality of life, autonomy and self esteem.

Nowadays, there exist in the market, wheelchairs to most types of mobile disability, with different sizes, formats, ergonomics, motorizations, interfaces, etc.

Albeit this huge variety of wheelchairs, they are still extremely expensive and the biggest problem consists on their reduced mobility, especially within a house, where the manoeuvres in small spaces are normally difficult to carry out and extremely exhausting.

The necessity for larger movements occurs when the environment where the wheelchair moves is a very restricted space. There exist many practical situations where the conventional wheelchairs are useless or not so practical, precisely due to the reduced mobility.

Just like a car has to be manoeuvred to park (this is the most tiring task carried out while driving a car), the same happens when a mobile disable has to move into a living house (he needs to perform many manoeuvres).

Some wheelchairs already come with driving motors to help disabled people with bigger physical limitations, or for disabled which need to go all over longer distances. Albeit, there still exist energy limitations due to the low lasting batteries, which are normally extremely heavy and that need many hours to recharge (normally 8-10 hours).

Document WO8603132 describes a wheelchair which contains many limitations and many differences when compared to this invention. The proposed wheelchair in this document has a different wheels circular offset and the wheels are different. Besides, it is not motorized and hasn't got the same easy manoeuvrability. The wheelchair in document WO8603132 does not allow performing any automatic control, nor recording any type of data which could help its user, in opposition to this present invention. The user interface is also very limited and is not very well adapted to be driven by people with any physical disability. This wheelchair has also a reduced autonomy.

Document JP2002029202 describes a vehicle which uses four omnidirectional wheels to perform movements in any direction. In opposition, the present invention system, although also allows the use of four wheels, can equally be used with only three wheels (preferred construction), which makes the manoeuvrability of this wheelchair easier. Besides this, in opposition to the invention describes in document JP2002029202, the present invention does not need a second person to push the chair.

Document JP2001233219 describes a vehicle which uses two omnidirectional wheels and, at least, one casting wheel. The present invention system proposes the usage of, at least three omnidirectional wheels, which makes the usage and manoeuvrability of this wheelchair easier. Besides this, this vehicle is not motorized and does not have autonomy, demanding a second person intervention in order to be pushed.

Document JP2001124054 describes a four omnidirectional wheels wheelchair not autonomous. By using four wheels a suspension system is needed to guarantee the four wheels are in permanent contact with the floor, otherwise the vehicle can drop over. In the present invention, although the system is able to cope with four wheels, it should preferably use three wheels. The three wheels usage avoids the necessity of a suspension.

Document U.S. Pat. No. 4,483,405 describes a non omnidirectional wheels wheelchair. Its simulated omnidirectionality is achieved in an indirect way, i.e. it is necessary to turn the wheels with the vehicle stopped in order to take the new desired direction. This vehicle is not advisable for people with a big physical disability or reduced physical capacity, since he needs extra human help for turning and moving the wheelchair.

Additionally, the omnidirectional wheels available in the market ignore the vibration problem. These omnidirectional wheels, although also have a central axle and two parallel rows of cylinders, they induce some vibration on the vehicles, in opposition to the omnidirectional wheels of this invention which have no vibration.

It is the cylinders that enable the omnidirectionality to the omnidirectional wheels. However, the wheel profile is not fully round due to the cylinders shape, which generates an oscillatory up and down movement, creating some discomfort on the wheelchair user. Comparatively, the omnidirectional Wheel of the present invention is made up by two rows (2) of four rugby ball shaped segments, creating a fully round wheel profile, eliminating any vibration associated with the wheelchair movement.

The present invention, by promoting an omnidirectional wheels wheelchair control system application, with its own motors, which drive independently each wheel, and controlled by a simple device on the wheelchair or wireless remote, helped by an easy interface used to define the direction to follow, sorts out the mobility problem of reduced physical capacity people. It also allows its user to take advantage of a greater manoeuvrability in reduced spaces like inside houses, when compared to the wheelchair described in the “state of the art”. Additionally, the rechargeable batteries or fuel cells allow its user to enjoy longer rides with improved autonomy.

It is important to point out that the present invention is not a simple combination of omnidirectional wheels with a motor, since independent and different forces are applied to each of the omnidirectional wheels, taking into account that each wheel has attached an independent motor, controlled by the processing unit, avoiding the necessity of complex manoeuvres or any physical effort by the user, and avoiding also the necessity of a second person's help to drive the wheelchair.

The use of a joystick, and the sensors on the wheelchair which provide information to the processing unit about existing obstacles, simplify even more the wheelchair manoeuvring in confined spaces.

It is also worth to mention the importance of using on this wheelchair control system the omnidirectional wheels which were specially designed for this purpose.

The present invention also sorts out the wheelchair autonomy, which was not considered on any of the previously referred documents, by using rechargeable batteries or fuel cells.

### INVENTION DESCRIPTION

The present invention consists of a control system for motorized wheels wheelchair which uses omnidirectional wheels.

This system is made up of a processing unit, which reads the control commands given by the user through a joystick or a similar device, and/or through a wireless remote control, and an interface like a tactile screen. This screen allows controlling the wheelchair movement in a simple way without much effort and it also allows the path definition.

The processing unit for the wheelchair control calculates each independent motor force to apply on the wheels, based on direction and speed parameters given by the user, and sends them to the motors accordingly. This system records continuously all the information from the sensors and actuators of the control system being therefore able to avoid obstacles and inform the user about the condition of the whole system, including the batteries autonomy.

The tactile screen interface can be used to input to the processing unit the wanted path to follow, in a simple and intuitive way, as well as to receive and display all the processed information by the system processing unit.

This wheelchair control system has also a processing unit, controllers, an interface screen and a base where at least three wheels coupled to the three motors are attached. These wheels were specially designed for this system.

These wheels allow the wheelchair to move in any direction without performing any manoeuvres. Thus, it is not necessary to turn the wheelchair in the direction of movement desired since it is possible for the wheelchair to move in any direction. This wheelchair can move sideways or in the diagonal direction, moving always in a straight line.

It is also possible to rotate the wheelchair at the same time that a linear movement is performed, in other words, it can rotate the wheelchair direction (to where it is facing to) while the wheelchair moves into another direction. This also means that the wheelchair can move in a different direction from the user is facing to.

The control system omnidirectional electric wheelchair of the present invention has also the capacity of moving sideways (left and right), keeping the same facing direction, in other words, without rotation. The same happens when performing diagonals.

Another important capacity of this new wheelchair operated through the control system of this invention, is the way it performs a rotation about itself. The rotation is carried out exactly through its central axle, which is not possible with a conventional wheelchair. The omnidirectional wheelchair can reverse its moving direction keeping the same position in space. The conventional wheelchair has the necessity of moving in space. If that necessary space does not exist, the wheelchair simply cannot perform that manoeuvre. The utilization of 4 omnidirectional wheels can imply the need to use suspension to guaranty that the 4 wheel touch always on the floor. The control system proposed in this invention, has a remotely controlled command so that a companion can command the wheelchair without being attached to any wiring, or for the user to bring the wheelchair to him, for example when he wants to get up from bed and the wheelchair is placed in the corner of the room at some distance. Another example of the remote control usage is in the case the user drives a car and after being seated on the driving seat, he wants to replace the wheelchair in the car boot (the car boot may possess a small automatic ramp for the wheelchair being able to climb it).

The proposed system of this invention allows the user to move the wheelchair, rotating about its central axis or moving in any direction, being only necessary for the user to specify to the control system the place to go.

The proposed system is electrically fed by rechargeable batteries or fuel cells, which allows reducing the wheelchair weight and therefore increase the autonomy.

### INVENTION ADVANTAGES

The main advantage of the motorized omnidirectional wheelchair control system is the easiness to manoeuvre the wheelchair, which leads to a less user physical effort necessary to perform the movement operations, a greater facility of movements inside a house with narrow spaces, a reduction of time necessary to perform the movement and a less energy (physical or electric) necessary to perform the movement. The possibilities of facing one direction while moving into another, and above all the increase of self esteem and autonomy of the mobile disabled user for not feeling so slow in his personal activities, represent great advantages for the user.

Another advantage of this wheelchair consists on the possibility, with the help of sensors around the wheelchair and connected to the on board processing unit, of obstacle detection and avoidance.

Besides all the already mentioned advantages, this system gives the user a higher autonomy because it is fed by rechargeable batteries or fuel cells. This is an important advantage for disable people.

### INVENTION DETAILED DESCRIPTION

An omnidirectional electric wheelchair control system involves the following elements:
Processing unit with reduced dimensions;
Commanding device;
User Friendly Interface, like a tactile screen;
Base/platform with at least three omnidirectional wheels driven by individual motors;
Rechargeable Batteries or fuel cells

Over this base/platform is attached the seat (seat is variable and depends on the type of disability) where the disabled will be seating.

The motors coupled with the omnidirectional wheels and are attached to the base (fist level of the structure), in a minimum number of three, as well as the batteries. The electronic devices necessary for the functioning of the system are located on the second level. On the next level up, is located the processing unit. Over this structure the seat is attached which is chosen by the user according to his disability. On the seat's arm a joystick or any other wheelchair controlling device is attached, and also a tactile screen where the user inputs/reads information to/from the wheelchair (8).

Even though typical omnidirectional wheels existent on the market can be used on this wheelchair control system, a specially developed omnidirectional wheel was designed to be used on this control system. The reason for developing this new wheel is to give the user higher comfort so that he does not feel vibration.

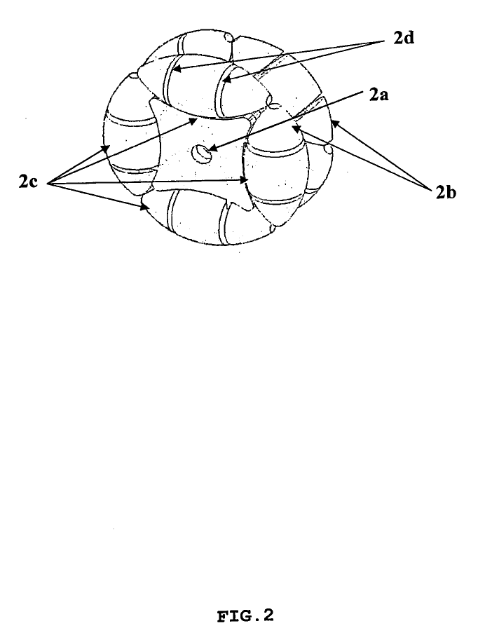

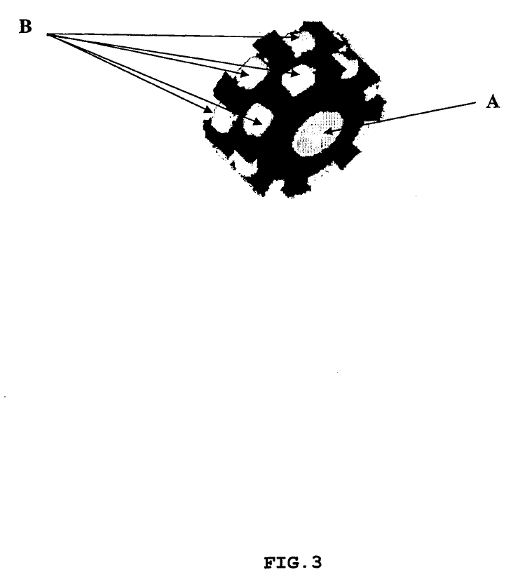

This wheel is made up of 2 rows (2c in FIG. 2) of 4 segments rugby ball shaped, taking into account that the overall wheel profile is completely round, eliminating though any vibration related to the chair's movement. The two rows are shifted 45 degrees in order to achieve this round shape. Each one of these elements is supported through two slots (2c in FIG. 2) in each of the parts which made up the wheel so that they are not in contact with the exterior (with the floor and with some dust which could accumulate).

Although this wheel is made up with several parts (not just one single part), it is designed to be robust so that it can support heavy weights without disassembling apart (as it happens with other traditional omnidirectional wheels).

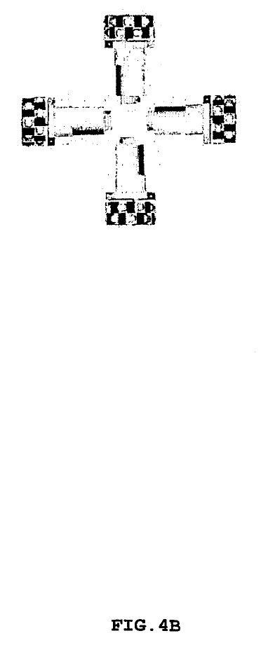

The omnidirectional wheels base/platform can be conceived to have three omnidirectional wheels (FIG. 4a), making sure the three wheels touch the floor simultaneously, but resulting in lower stability. With the use of four omnidirectional wheels, as specified in FIG. (4b), it could happen that one of the wheels does not touch the floor, but it means higher stability and comfort. By using three omnidirectional wheels there will be an offset of 120 degrees between them. By using four omnidirectional wheels there will be an offset of 90 degrees between them.

On top of this base/platform, is then adapted the seat for the use, according to his specific needs.

Still as part of this wheelchair control system, a processing unit with reduced dimensions to control the whole electronics needed to the wheelchair movements, one or more control commands like a joystick and/or through a wireless remote control, an interface like a tactile screen, or other traditional input devices used in wheelchairs, chosen accordingly to the user disability, able to easily control the chair movements by the user through an user friendly and configurable.

Also part of this wheelchair control system is a set of rechargeable batteries or fuel cells to feed the electrical motors.

### PICTURES BRIEF DESCRIPTION

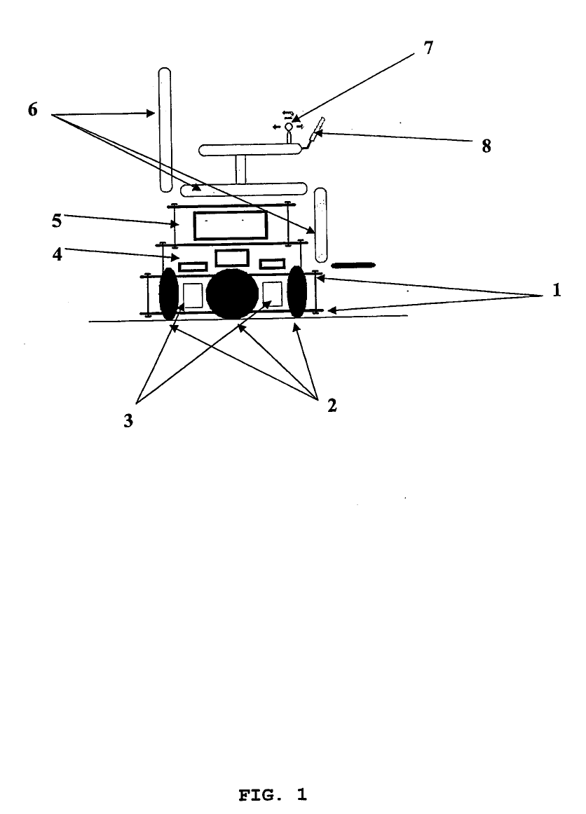

FIG. 1 represents the complete system with all its components: the base (1) where the motors are attached coupled with the wheels (2), as well as the batteries (3). The electronic devices necessary for the functioning of the system are located on the second level (4). On the next level up, is located the processing unit (5). Over this structure the seat is attached (6). On the seat's arm a joystick or any other wheelchair controlling device is attached (7), as well as a tactile screen where the user inputs/reads information to/from the wheelchair (8).

FIG. 2 shows the omnidirectional wheel design, which has a central axis (where the motor axle will be attached) specified by (2a) and two rows of cylinders (with a rugby ball shape), specified by (2c). Each cylinder has two slots (2d) through which the supporting axis are inserted, and this allows a better support, longer lasting and without easily bending.

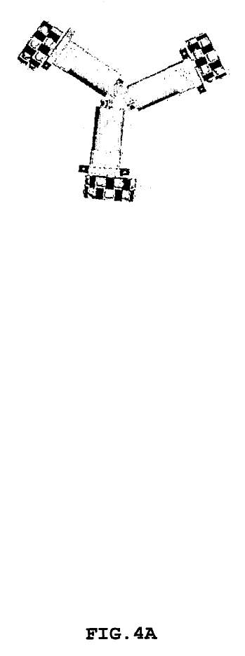

FIG. 3 shows an example of an existing omnidirectional wheel with the vibration problem. This omnidirectional wheel also has a central axis specified by (A) and two parallel rows with small cylinders specified by (B).

FIG. 4 represents the bases/platforms where the omnidirectional wheels are attached to. These bases/platforms can use 3 omnidirectional wheels, meaning they will have an offset of 120 degrees between them (4a). These bases/platforms can also use 4 omnidirectional wheels, as specified in FIG. (4b), meaning in this case they will have an offset of 90 degrees between them.

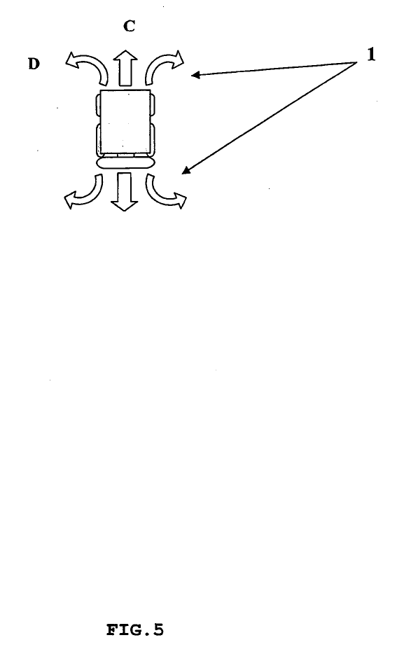

FIG. 5 shows that in a traditional wheelchair the possible movements are only to the front or backwards (as specified in (C), allowing rotation to point the new direction (D), although that movement being not easy due to the 4 traditional wheels being offset.

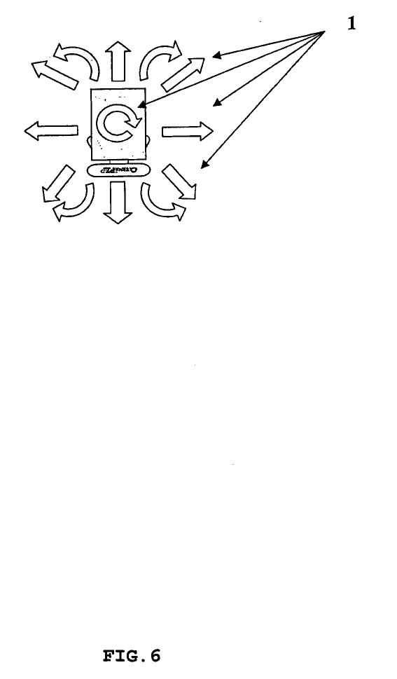

FIG. 6 shows that, on the omnidirectional wheelchair, each wheel has an independent motor attached to making it a driving wheel. The set of movements, either using 3 or 4 wheels, offers the omnidirectionality to the wheelchair, allowing it to move in any direction, rotate over itself, or drive the two different movements at the same time, as specified in (1).

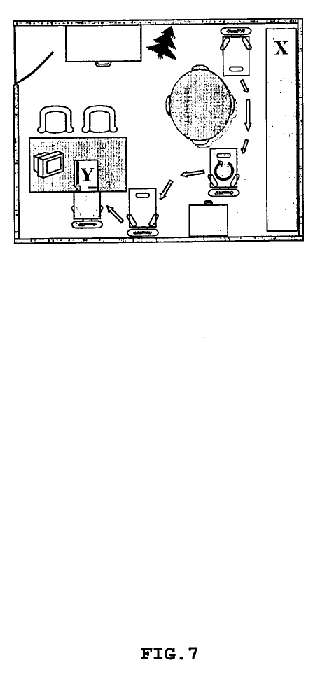

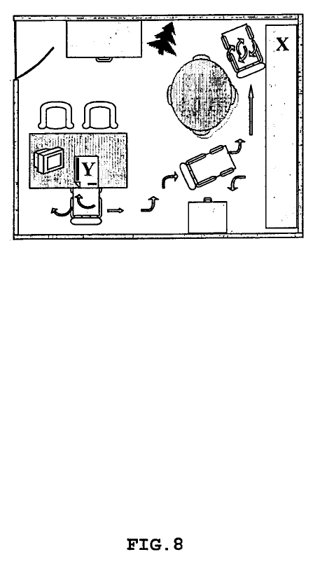

FIGS. 7 and 8 show the amount of manoeuvres necessary for, the traditional wheelchair and the present invention, moving from point X to point Y is small spaces. The control system of the present invention (FIG. 8), it is easier to me in any direction with any orientation.

1. Omnidirectional wheelchair control system characterized by having a base (1) with at least three omnidirectional wheels (2) attached with the same number of motors independent, being each of this associated to the referred omnidirectional wheels, a data processing unit (5), electronic devices essential to the system functioning (4), at least one movement control device, fixed (7) or wireless remote, a communication interface between the several components of the system, a set of sensors and also being fed by rechargeable batteries (3) or fuel cells.

2. Omnidirectional wheelchair control system, according to demand 1, characterized by a base which can have attached three motorized omnidirectional wheels, with an offset of 120 degrees between them, or four omnidirectional motorized wheels with an offset of 90 degrees between them.

3-8. (canceled)

9. Omnidirectional wheelchair control system, according to the demand 1, characterized by the controlling device being preferably a joystick.

10. Omnidirectional wheelchair control system, according to the demand 1, characterized by having an extra wireless remote control with the same functionalities as the main command of the wheelchair.

11. Omnidirectional wheelchair control system, according to the demand 1, characterized by having as interface a tactile screen, which is used to communicate all information between the user and all the components of the system, as well as to display the recorded information made by the processing unit.

12. Omnidirectional wheelchair control system, according to the demand 1, characterized by having several sensors attached to the wheelchair which detect obstacles.

13. (canceled)
